(19) United States
(12) Patent Application Publication
(10) Pub. No.: US 2001/0028175 A1
(43) Pub. Date: Oct. 11, 2001

(54) Robot for an industrial automation system

(76) Inventors: Brian K. Thompson, Elyria, OH (US); Theodore S. Zajac JR., Elyria, OH (US)

Correspondence Address: Cynthia S. Murphy, Renner, Otto, Boisselle, & Sklar, L.L.P., 19th Floor, 1621 Euclid Avenue, Cleveland, OH, 44115, US

(21) Appl. No.: 09/789,689

(22) Filed: Feb. 21, 2001

Related U.S. Application Data
(63) Continuation of application No. 09/543,857, filed on Apr. 5, 2000.
(60) Provisional application No. 60/128,097, filed on Apr. 7, 1999.

(51) Int. Cl. B66C 1/42

(52) U.S. Cl. 294/119.1; 901/25; 901/38

(57) ABSTRACT

An industrial automation robot including a locating member (e.g., a robotic arm), a gripper movable by the locating member to a position aligned with a workpiece, and a pair of jaws attached to the gripper's slides for engaging the workpiece. A driving interconnection between the gripper's slides and the gripper's drive assembly moves the slides towards each other when a drive rod is rotated in a first direction and moves the slides away from each other when the drive rod is rotated in a second direction. The driving interconnection between the slides and the driving assembly preferably further insures synchronous movement of the slides, and thus the jaws, relative to the frame when the drive rod is rotated.

### RELATED APPLICATIONS

This application claims priority under 35 U.S.C. §119(e) to U.S. Provisional Patent Application No. 60/128,097 filed on Apr. 7, 1999. The entire disclosure of this provisional application is hereby incorporated by reference.

### FIELD OF THE INVENTION

The present invention relates to a robotic gripper for gripping a workpiece during industrial automation.

### BACKGROUND OF THE INVENTION

Automation is the common element today in industrial manufacturing. Computers, sensors, robots, machine vision, adaptive control and artificial intelligence are being applied by manufacturing engineers to perform the manufacturing processes once carried out by human beings. Improved quality, smaller lot sizes, more product options, and reduction in price have been benefits of the improved technology. Little, if any, operator interaction is required once the automation equipment has been set up.

An industrial automation system typically employs one or more robots for picking up, transferring and/or depositing workpieces. A robot is device that automatically performs complicated often repetitive tasks and/or a mechanism guided by automatic controls. For example, a robot can take the place of a human operator for workpiece load and unload functions.

A robot typically comprises a locating member and a gripper attached to the locating member. The locating member positions the gripper at a predetermined location relative to the workpiece so that the gripper may grip the workpiece. A sophisticated robot may be programmable to perform different tasks and its locating member may comprise an articulated robotic arm having a series of computer-controlled, joint-actuated, open kinematic chains terminating at the gripper. A more simplified robot may be dedicated to perform only one task and its locating member may comprise, for example, a sliding member movable between as few as two positions, the gripper being attached to the slide for movement therewith.

A pair of jaws are attached to the gripper so that, when the gripper is activated, the jaws will grip the workpiece. A parallel gripper, for example, typically includes a pair of slides to which the jaws are secured. Movement of the slides toward and away from each other provide for respective movement of the jaws so that they can grip and release a workpiece. In the past, this movement has been accomplished by providing fluid-powered pistons to move the slides thereby requiring a pressurized fluid source at the industrial automation site (e.g., pressurized air, hydraulic oil, etc.).

It is important that the jaws move synchronously when gripping the workpiece. In the past, this has been accomplished by providing some type of means for synchronizing the movement of the slides. For example, in U.S. Pat. No. 5,657,973 (assigned to the assignee of the present invention), a longitudinally extending rod ensures synchronous movement of fluid-powered pistons and thereby synchronous movement of the slides. Specifically, the opposite ends of the rod have respective right and left hand splines in axially extending openings of the pistons thereby providing a driving interconnection between the pistons and the rod. As the pistons move towards and away from each other, the rod rotates and the engagement of the splines ensures that the pistons move at the same rate to ensure synchronous movement of the pistons.

### SUMMARY OF THE INVENTION

The present invention provides a robot wherein the movement of the gripper's slides is accomplished by a drive assembly powered by an electric motor. In this manner, a separate pressurized fluid source is not required at the automation site. Since almost all (if not all) industrial automation systems typically run on electric servomotors, the systems are designed with an electricity source and thus electricity is already available for the actuation of the gripper.

The present invention additionally or alternatively provides a robotic gripper wherein the driving interconnection between the slides and the driving assembly insures synchronous movement of the slides, and thus the jaws. In this manner, a separate or additional synchronizing means is not necessary.

More particularly, the present invention provides a robot comprising a locating member, a gripper movable by the locating member to a position aligned with a workpiece, and a pair of jaws attached to the gripper for engaging the workpiece. The gripper includes a frame, a pair of slides, a drive assembly, and a driving interconnection between the slides and the drive assembly. The slides are movably mounted to the frame and the jaws are attached to the slides for movement therewith. The drive assembly comprises a drive rod and a rotary motor (e.g., an electric motor) operably coupled to the drive rod to rotate the drive rod in a first direction and a second opposite direction.

The driving interconnection between the slides and the drive assembly moves the slides toward each other when the drive rod is rotated in the first direction and moves the slides away from each other when the drive rod is rotated in the second direction. Preferably, this driving interconnection further ensures synchronous movement of the slides, and thus the jaws, relative to the frame when the drive rod is rotated.

The preferred interconnection comprises right-hand threads on one of the slides which engage with right-hand threads on a portion of the drive rod and left-hand threads on the other of the slides which engage with left-hand threads on another portion of the drive rod. More preferably each of the slides includes a bore having the threads formed thereon and the threaded portions of the drive rod extend through the bores of the respective slides.

These and other features of the invention are fully described and particularly pointed out in the claims. The following descriptive annexed drawings set forth in detail certain illustrative embodiments of the invention, these embodiments being indicative of but a few of the various ways in which the principles of the invention may be employed.

### DRAWINGS

FIG. 1 is schematic illustration of an industrial automation system including a robot according to the present invention, the robot including a locating member, a gripper movable by the locating member, and a pair of jaws attached to the gripper which engage a workpiece.

FIG. 2 is a front view of the gripper with the jaws attached thereto, the gripper being shown with in an open condition.

FIG. 3 is another front view of the gripper with the jaws attached thereto, the gripper being shown in a closed condition gripping the workpiece.

FIG. 4 is a top view of the gripper (without the jaws attached thereto) in the open condition.

FIG. 5 is another top view of the gripper (without the jaws attached thereto) in the closed condition.

FIG. 6 is a right-hand end view of the gripper.

### DETAILED DESCRIPTION

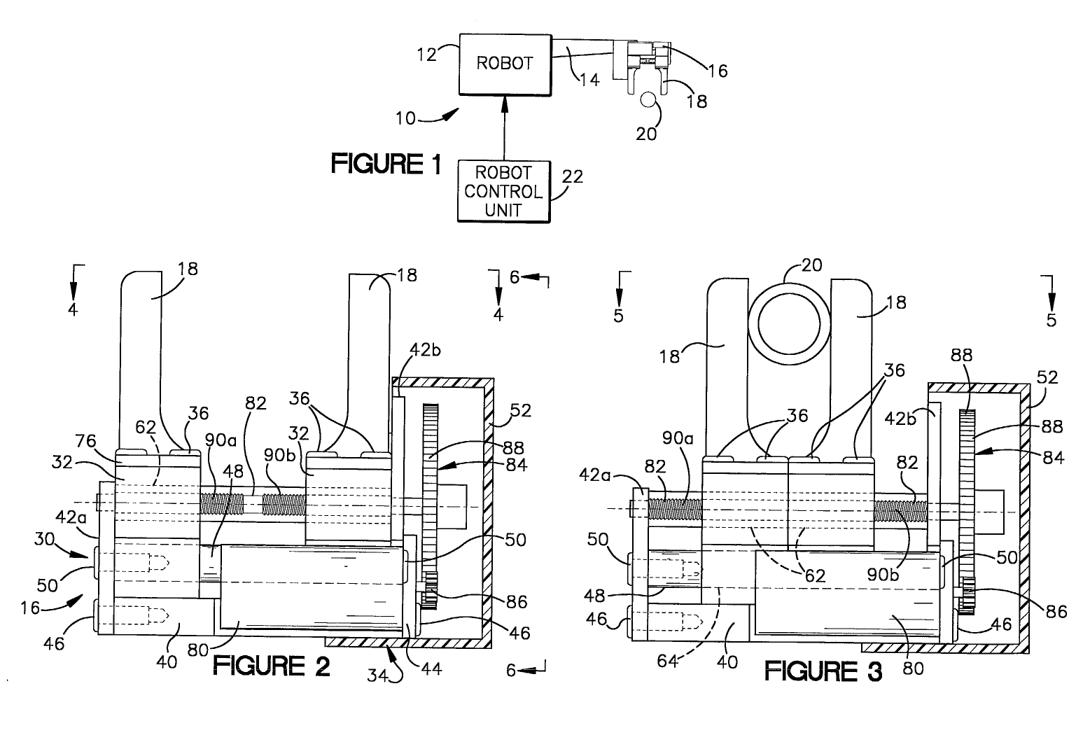

An industrial automation system 10 including a robot 12, or industrial automation device, according to the present invention is schematically shown in FIG. 1. The robot 12 includes a locating member 14 a gripper 16 and a pair of jaws 18. In the illustrated embodiment, the robot 12 is a somewhat sophisticated robot and its locating member 14 is an articulated robotic arm. However, other robots and/or other locating members are possible with and contemplated by the present invention. For example, the robot 12 could designed to perform only one dedicated task and its locating member 14 could comprise, for example, a sliding member movable between as few as two positions with the gripper attached thereto.

During operation of the system 10, the robotic arm 14 positions the gripper 16 at a location defined by predetermined coordinates aligned with a workpiece 20 on a loading stage. The jaws 18 are attached to the gripper 16 so that, when the gripper 16 is activated, the jaws 18 will grip the workpiece 20. The system 10 may further include a control unit 22 to coordinate the positioning of the locating member 14 and/or the activation of the gripper 16.

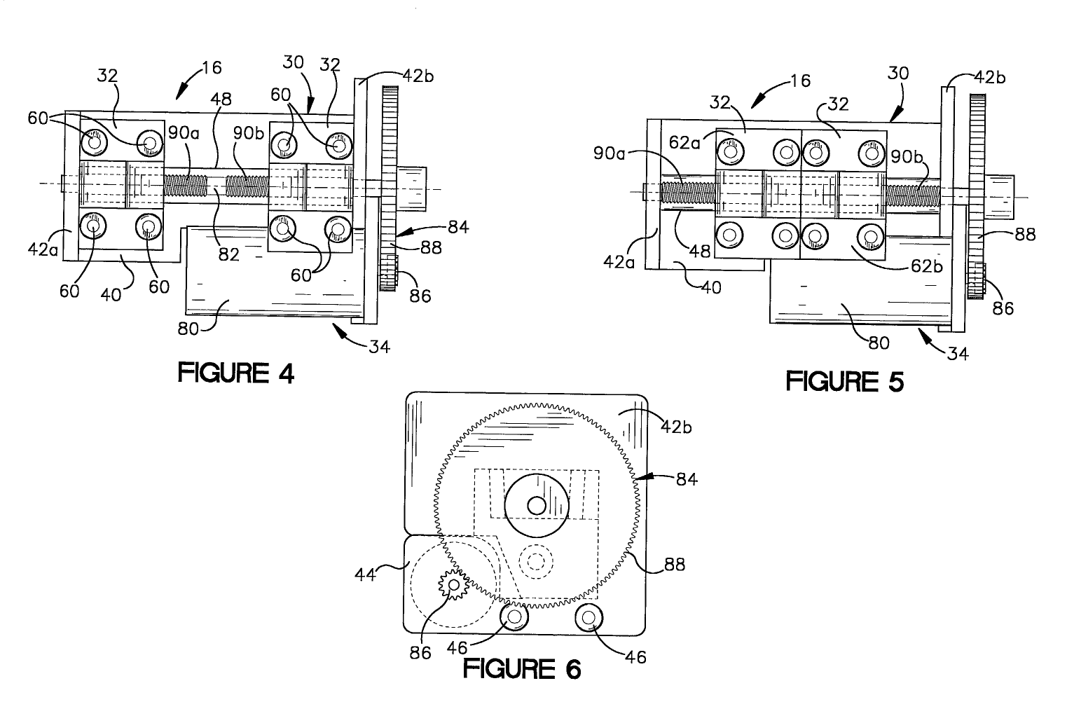

The gripper 16 and the jaws 18 are shown isolated from the rest of the robot 12 in FIGS. 2 and 3, and the gripper 16 is shown isolated from jaws 18 in FIGS. 4-6. The gripper 16 comprises a frame 30, a pair of slides 32, and a drive assembly 34. The slides 32 are mounted to the frame 30 for linear movement relative thereto and the jaws 18 are attached to the slides 32 by suitable fasteners 36. As is explained in more detail below, there is a driving interconnection between the slides 32 and the drive assembly 34. This interconnection moves the slides 32 towards each other to grip the workpiece (FIG. 3) and moves the slides away from each other to place the gripper 16 in an open condition (FIG. 4). As is also explained in more detail below, this driving interconnection further insures synchronous movement of the slides 32, and thus the jaws 18, relative to the frame 30.

In the illustrated embodiment, the workpiece 20 is a tube, however, a system 10, a robot 12, and/or jaws 18 that accommodate other types of workpieces are certainly possible with and contemplated by the present invention. Also in the illustrated embodiment, the slides 32 move towards each other to grip the workpiece 20 and their gripping position is shown as their innermost position relative to the frame 30. However, in many instances, the gripping position of the slides 32 will be somewhere between their innermost and outermost positions. Additionally, in some situations, the slides 32 will grip the workpiece 20 by moving away from, rather than towards, each other.

The frame 30 preferably comprises a series of plates forming the structural skeleton for the slides 32 and the drive assembly 34. The illustrated frame 30 includes a base plate 40, end plates 42a and 42b and a motor mounting plate 44. The end plates 42 are attached to the base plate 40 by suitable fasteners 46 and the motor mounting plate 44 is formed in one piece with the right-hand end plate 42b. The frame 30 may additionally include a guide rod 48, such as a cylindrical bar, attached to and extending between the end plates 42 by suitable fasteners 50. As is shown in FIGS. 2 and 3, a cover 52 may be provided to conceal and protect certain components of the drive assembly 34 (namely a gear train 84, introduced below) positioned on the outer side of the right hand end plate 42b and the motor mounting plate 44.

The slides 32 are each, in the illustrated embodiment, block-shaped members having upper openings 60 (see FIGS. 4 and 5) for attachment of the jaws 18 thereto by the fasteners 36 (see FIGS. 2 and 3). Other attachment means for the jaws 18 are possible with and contemplated by the present invention. For example, other fastening arrangements, adhesive connections, welded joints, etc. may be suitable attachment means depending on the circumstances.

As was indicated above, there is a driving interconnection between the slides 32 and the drive assembly 34. As part of the driving interconnection, the left-hand slide 32a includes a left-hand threaded bore 62a and the right-hand slide 32b includes a right-hand threaded bore 62b. The bottom surface of the slides 32 rests upon the frame's base plate 40 and the slides 32 additionally each include a bore 64 for sliding receipt of the guide rod 48.

The drive assembly 34 comprises a reversible rotary motor 80, a drive rod 82, and a gear train 84 which transfers rotary motion from the motor 80 to the drive rod 82. The motor 80 is preferably an electric motor 80, although in certain situations, such as an industrial automation system handling potentially explosive materials, an air-powered or other non-electric rotary motor may be used instead. The motor 80 and/or the drive assembly 34 may include an encoder 85 for conveying information to the robot control unit 22 regarding size of the work piece 20, the location of the jaws 18, etc.

The motor 80 is mounted to the frame plate 44 and the end of its shaft extends slightly therethrough. The drive rod 82 extends between the end plates 42 and its ends are rotatably supported by suitable bearing openings. The gear train 84 is mounted on the outer sides of the right-hand end plate 42b and the motor mounting plate 44. The illustrated gear train 84 comprises a motor gear 86 attached to the motor's shaft and a drive gear 88 attached to the right hand end of the drive rod 82, however other gear trains and/or other motion-transferring means (e.g., belts) are possible with and contemplated by the present invention.

The driving interconnection between the slides 32 and the drive assembly 34 includes a left-hand threaded portion 90a and a right-hand threaded portion 90b. These threaded portions 90a and 90b extend through the threaded bores 62a and 62b whereby the respective threads mate. When the motor 80 is rotated in a first direction (clockwise in FIG. 6) and this motion is transferred to the drive rod 82 by the gear train 84, the slides 32 are moved towards each other. When the motor 80 is rotated in a second opposite direction (clockwise in FIG. 6), the slides 32 are likewise moved away from each other. The slides's bottom surfaces slide along the frame's base plate 40 during this movement whereby rotation of the slides is prevented.

Thus the threaded interconnection between the slides 32 and the drive assembly 34 transforms the rotary motion of the electric motor 80 into linear motion between the two jaws 18. Also, this interconnection also ensure that the linear movement of the two slides is at the same rate whereby the jaws will move synchronously when gripping the workpiece.

One many now appreciate that the present invention provides a robot 12 wherein the movement of the gripper's slides 32 towards and away from each other is accomplished by a drive assembly 34 powered by an electric motor 80 whereby a separate pressurized fluid source is not required at the automation site. One may also now appreciate that the present invention additionally or alternatively provides a robotic gripper wherein the driving interconnection between the slides 32 and the driving assembly 34 insures synchronous movement of the slides 32, and thus the jaws 18 whereby a separate or additional synchronizing means is not necessary.

Although the invention has been shown and described with respect to certain preferred embodiments, it is obvious that equivalent and obvious alterations and modifications will occur to others skilled in the art upon the reading and understanding of this specification. The present invention includes all such alterations and modifications and is limited only by the scope of the following claims.

1. A robot comprising a locating member, a gripper, and a pair of jaws;
the gripper being attached to the locating member and the locating member positioning the gripper at a location aligned with a workpiece;
the pair of jaws being attached to the gripper to engage the workpiece when the gripper is activated;
the gripper comprising a frame, a pair of slides, a drive assembly, and a driving interconnection between the slides and the drive assembly;
the slides being movably mounted to the frame and the jaws being attached to the slides for movement therewith;
the drive assembly comprising a drive rod and a rotary motor operably coupled to the drive rod to rotate the drive rod in a first direction and a second opposite direction;
the driving interconnection between the slides and the drive assembly moving the slides towards each other when the drive rod is rotated in the first direction and moving the slides away from each other when the drive rod is rotated in the second direction.

2. A robot as set forth in claim 1 wherein the driving interconnection between the slides and the driving assembly further insures synchronous movement of the slides, and thus the jaws, relative to the frame when the drive rod is rotated.

3. A robot as set forth in claim 2 wherein the driving interconnection comprises right-hand threads on one of the slides which engage with right-hand treads on a portion of the drive rod and left-hand threads on the other of the slides which engage with left-hand threads on another portion of the drive rod.

4. A robot as set forth in claim 3 wherein each of the slides includes a bore having the threads formed thereon and wherein the threaded portions of the drive rod extend through the bores of the respective slides.

5. A robot as set forth in claim 4 wherein the drive assembly further comprises a gear train which couples the motor to the drive rod, and the motor is an electric motor.

6. A robot as set forth in claim 5 wherein the gear train comprises a motor gear coupled to the motor and a drive gear coupled to the drive rod.

7. A robot as set forth in claim 5 wherein the drive assembly further comprises a gear train which couples the motor to the drive rod.

8. A robot as set forth in claim 7 wherein the gear train comprises a motor gear coupled to the motor and a drive gear coupled to the drive rod.

9. A robot as set forth in claim 4 wherein the grippe r further comprises a guide rod which guides the movement of the slides when the drive rod in rotated.

10. A robot as set forth in claim 9 wherein the slides are slid ably mounted relative to the guide rod.

11. A robot as set forth in claim 10 wherein the guide rod extends through bores in the slides.

12. A robot as set forth in claim 1 wherein the motor is an electric motor.

13. A robot as set forth in claim 1, wherein the locating member comprises a robotic arm.

14. A robotic gripper, comprising:
a frame,
a pair of slides movably mounted to the frame and including means for attaching jaws thereto for movement therewith;
a drive assembly comprising a drive rod and a rotary electric motor operably coupled to the drive rod which rotates the drive rod in a first direction and a second opposite direction; and
a driving interconnection between the slides and the drive assembly which moves the slides towards each other when the drive rod is rotated in the first direction and moves the slides away from each other when the drive rod is rotated in the second direction causing the jaws to grip a workpiece.

15. A robotic gripper as set forth in claim 14 wherein the driving interconnection between the slides and the driving assembly further insures synchronous movement of the slides, and thus the jaws, relative to the frame when the drive rod is rotated.

16. A robotic gripper as set forth in claim 15 wherein the driving interconnection comprises right-hand threads on one of the slides which engage with right-hand threads on a portion of the drive rod and left-hand threads on the other of the slides which engage with left-hand threads on another portion of the drive rod.

17. A robotic gripper as set forth in claim 16 wherein each of the slides includes a bore having the threads formed thereon and wherein the threaded portions of the drive rod extend through the bores of the respective slides.

18. A robotic gripper as set forth in claim 14 further comprising a pair of jaws attached to the slides.

19. A robotic gripper as set forth in claim 14 wherein the motor is an electric motor.

20. A method of industrial automation comprises the steps of:
positioning a workpiece on a work stage;
locating the gripper of claim 14 at a position aligned with the staged workpiece; and
activating the motor to rotate the drive rod in the first direction whereby the slides are moved towards each other.

21. A method as set forth in claim 19 further comprising the step of activating the motor to rotate the drive rod in the second direction whereby the slides are moved away from each other.

22. An industrial automation device comprising a locating member, a gripper, and a pair of jaws;
the gripper being attached to the locating member and the locating member positioning the gripper at a location aligned with a workpiece;
the pair of jaws being attached to the gripper to engage the workpiece when the gripper is activated;
the gripper comprising a frame, a pair of slides, a drive assembly, and a driving interconnection between the slides and the drive assembly;
the slides being movably mounted to the frame and the jaws being attached to the slides for movement therewith;
the drive assembly comprising a drive rod and a rotary motor operably coupled to the drive rod to rotate the drive rod in a first direction and a second opposite direction;
the driving interconnection between the slides and the drive assembly moving the slides towards each other when the drive rod is rotated in the first direction and moving the slides away from each other when the drive rod is rotated in the second direction.

23. A gripper, comprising:
a frame,
a pair of slides movably mounted to the frame and including means for attaching jaws thereto for movement therewith;
a drive assembly comprising a drive rod and a rotary electric motor operably coupled to the drive rod which rotates the drive rod in a first direction and a second opposite direction; and
a driving interconnection between the slides and the drive assembly which moves the slides towards each other when the drive rod is rotated in the first direction and moves the slides away from each other when the drive rod is rotated in the second direction causing the jaws to grip a workpiece.

24. A robot comprising a locating member, a gripper, and a pair of jaws;
the gripper being attached to the locating member and the locating member positioning the gripper at a location aligned with a workpiece;
the pair of jaws being attached to the gripper to engage the workpiece when the gripper is activated;
the gripper comprising a frame, a pair of slides, a drive assembly, and a driving interconnection between the slides and the drive assembly;
the slides being movably mounted to the frame and the jaws being attached to the slides for movement therewith;
the drive assembly comprising an electric motor for moving the slides towards and away from each other thereby moving the jaws towards and away from each other to grip a workpiece.

25. A robot comprising a locating member, a gripper, and a pair of jaws;
the gripper being attached to the locating member and the locating member positioning the gripper at a location aligned with a workpiece;
the pair of jaws being attached to the gripper to engage the workpiece when the gripper is activated;
the gripper comprising a frame, a pair of slides, a drive assembly, and a driving interconnection between the slides and the drive assembly;
the slides being movably mounted to the frame and the jaws being attached to the slides for movement therewith;
the driving interconnection between the slides and the drive assembly moving the slides towards each other while at the same time insuring synchronous movement of the slides and thus the jaws, relative to the frame.
